(19) United States
(12) Patent Application Publication
(10) Pub. No.: US 2020/0249694 A1
(43) Pub. Date: Aug. 6, 2020

(54) Dynamic Digital Fencing

(71) Applicant: Eaton Intelligent Power Limited, Dublin 4 (IE)

(72) Inventors: Parth Joshi, Atlanta, GA (US); Nam Chin Cho, Peachtree City, GA (US); Joseph M. Semaan, Peachtree City, GA (US); Russell Scott Trask, Sharpsburg, GA (US)

(21) Appl. No.: 16/782,898

(22) Filed: Feb. 5, 2020

Related U.S. Application Data
(60) Provisional application No. 62/802,141, filed on Feb. 6, 2019.

(51) Int. Cl. G05D 1/02

(52) U.S. Cl. CPC G05D 1/0276

(57) ABSTRACT

A digital fencing system includes a first lighting fixture that includes a first communication module, and a second lighting fixture that includes a second communication module. The digital fencing system also includes a control device configured to receive first information from the first lighting fixture. The first information is related to a wireless signal transmitted by a mobile entity and received by the first lighting fixture. The control device is further configured to receive second information from the second lighting fixture. The second information is related to the wireless signal transmitted by the mobile entity and received by the second lighting fixture. The control device is also configured to transmit a control message to the mobile entity to control a movement of the mobile entity based on a location of the mobile entity with respected to a permitted area.

### CROSS REFERENCE TO RELATED APPLICATIONS

The present application claims priority under 35 U.S.C. Section 119(e) to U.S. Provisional Patent Application No. 62/802,141, filed Feb. 6, 2019 and titled “Dynamic Digital Fencing,” the entire content of which is incorporated herein by reference.

### TECHNICAL FIELD

The present disclosure relates generally to lighting systems, and more particularly to using lighting devices with integrated components to establish movement boundaries and to guide movements.

### BACKGROUND

Some robotic devices may operate outdoors to perform tasks with limited or no human control. For example, some robotic lawn mowers may cut grass and even return to a charging station without human control. Similarly, some robotic devices, such as robotic vacuum cleaners, operate indoor to clean an indoor space. In general, the areas that are covered by indoor and outdoor robotic devices are limited by physical structures such as fences, walls, etc. As robotic devices move around in an area, the robotic devices generally use built-in sensors to avoid objects such as obstacles, fences, walls, etc. and are generally limited by structures such as physical fences, walls, etc. However, limiting the operations of robotic devices to an area that is not bound by physical structures, such as a physical fence, may be challenging. A similar challenge may also exist in other cases, such as limiting movements of pets and even humans, when a physical structure is unavailable to limit movements. Further, in the absence of physical structures that limit movements, robotic devices may be unable to take a desired path between particular locations. Thus, a solution that enables limiting the movements of robotic devices as well as pets, etc. may be desirable.

### SUMMARY

The present disclosure relates generally to lighting systems, and more particularly to using lighting devices with integrated components to establish movement boundaries and to guide movements. In an example embodiment, a digital fencing system includes a first lighting fixture that includes a first communication module, and a second lighting fixture that includes a second communication module. The digital fencing system also includes a control device configured to receive first information from the first lighting fixture. The first information is related to a wireless signal transmitted by a mobile entity and received by the first lighting fixture. The control device is further configured to receive second information from the second lighting fixture. The second information is related to the wireless signal transmitted by the mobile entity and received by the second lighting fixture. The control device is also configured to transmit a control message to the mobile entity to control a movement of the mobile entity based on a location of the mobile entity with respected to a permitted area, where the location of the mobile entity is determined based on at least the first information and the second information.

In another example embodiment, the present disclosure is directed to a non-transitory computer-readable medium of a controller, where the non-transitory computer-readable medium contains instructions executable by a processor. The instructions include receiving first information from the first lighting fixture, where the first information is related to a wireless signal transmitted by a mobile entity and received by the first lighting fixture. The instructions further include receiving second information from the second lighting fixture, where the second information is related to the wireless signal transmitted by the mobile entity and received by the second lighting fixture. The instructions also include transmitting, via a transmitter, a control message to the mobile entity to control a movement of the mobile entity based on a location of the mobile entity with respected to a permitted area, where the location of the mobile entity is determined based on at least the first information and the second information.

In another example embodiment, a digital fencing system includes a first lighting fixture that includes a first communication module, and a second lighting fixture that includes a second communication module. The digital fencing system further includes a control device configured to receive a first video or image from the first lighting fixture, receive a second video or image from the second lighting fixture, and transmit a control message to the mobile entity to control a movement of the mobile entity based on a location of the mobile entity relative to a permitted area. The location of the mobile entity is determined based on at least the first video or image and the second video or image.

### BRIEF DESCRIPTION OF THE FIGURES

Reference will now be made to the accompanying drawings, which are not necessarily drawn to scale, and wherein:

FIG. 1 illustrates a lighting system of lighting devices used to establish a digital fence based on a wireless signal from a mobile entity according to an example embodiment;

FIG. 2 illustrates a lighting device according to an example embodiment;

FIG. 3 illustrates the lighting system of FIG. 1 used to establish multiple digital fences based on wireless signals from mobile entities according to an example embodiment;

FIG. 4 illustrates the lighting system of FIG. 1 used to establish multiple digital fences based on wireless signals from mobile entities according to another example embodiment;

FIG. 5 illustrates a lighting system of lighting devices used to establish a digital fence based on image analysis according to an example embodiment;

FIG. 6 illustrates a lighting system of lighting devices used to establish a digital fence based on a wireless signal from a mobile entity according to another example embodiment;

FIG. 7 illustrates a lighting system of lighting devices used to establish a digital fence based on image analysis according to another example embodiment; and

FIG. 8 illustrates the lighting system of FIG. 7 used to guide a mobile entity based on image analysis according to another example embodiment.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different drawings may designate like or corresponding, but not necessarily identical elements.

### DETAILED DESCRIPTION OF THE EXAMPLE EMBODIMENTS

In the following paragraphs, example embodiments will be described in further detail with reference to the figures. In the description, well-known components, methods, and/or processing techniques are omitted or briefly described. Furthermore, reference to various feature(s) of the embodiments is not to suggest that all embodiments must include the referenced feature(s).

In some example embodiments, a lighting system may include multiple lighting devices such as lighting fixtures that are installed at various locations throughout an outdoor or indoor space. These lighting fixtures may include a respective communication module that can receive and transmit wireless signals, such as Wi-Fi signals. For example, the lighting fixtures may receive a wireless signal from a mobile entity (e.g., a robotic lawn mower, a pet collar worn by a pet, a robotic vacuum cleaner, etc.) and process the wireless signal to extract information transmitted by the mobile entity. To illustrate, the lighting fixtures may extract information that indicates the transmission power level of the wireless signal at transmission by the mobile entity, the time of transmission of the wireless signal by the mobile entity, and/or other information that can be used to determine the location of the mobile entity. The lighting fixtures may also determine other information such as the power level of the wireless signal at reception of the wireless signal by the lighting fixtures. The lighting fixtures may also determine the time of arrival of the wireless signal at the lighting fixtures. The lighting fixtures may transmit to a control device some or all of the information extracted and/or determined from the wireless signal including the time of arrival information. The control device may process the information received from the lighting fixtures and estimate the location of the mobile entity based on the information. Depending on the estimated location of the mobile entity, the control device may transmit a control message to the mobile entity, for example, to limit the movement of the mobile entity to within a certain area, effectively establishing (e.g., equivalently, enforcing) a digital fence.

In some example embodiments, the lighting fixtures may include a camera that captures video or still images. The lighting fixtures may use cameras to capture images, and the lighting fixtures may transmit the images to the control device. The control device may perform image analysis to identify one or more mobile entities (e.g., a robotic lawn mower, a robotic vacuum cleaner, a pet collar worn by a pet, etc.) as well as to identify static objects, structures, and areas (e.g., a grass lawn, a street, furniture, a wall, a carpet, a hardwood floor, etc.). The control device may also estimate the distance between mobile entities and objects/structures/areas (which may be herein referred to individually as a structure or collectively as structures). Depending on the estimated distance, the control device may transmit a control message to the mobile entity, for example, to limit the movement of the mobile entity to within a certain area, effectively establishing a digital fence.

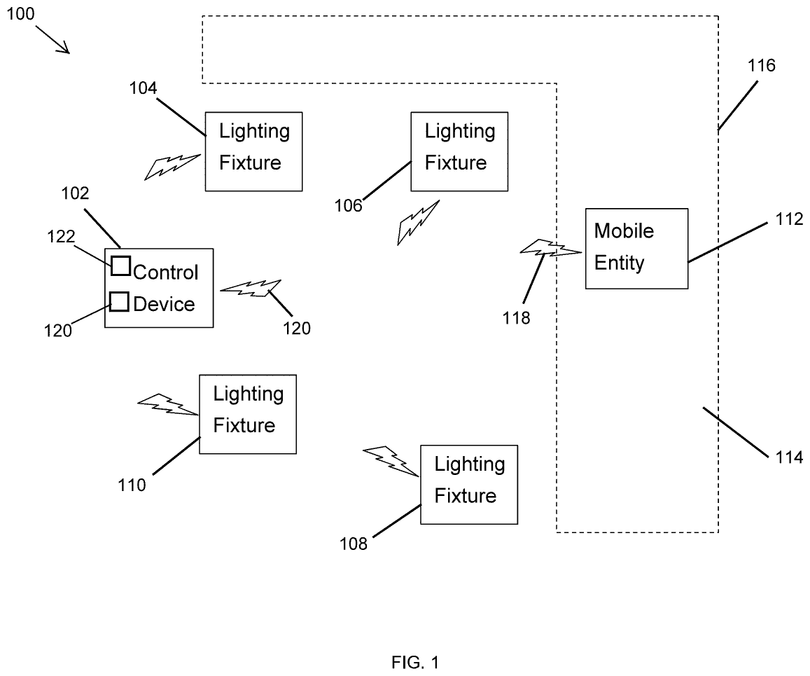

Turning now to the figures, particular example embodiments are described. FIG. 1 illustrates a lighting system 100 of lighting devices used to establish a digital fence 116 based on a wireless (RF) signal 118 from a mobile entity 112 according to an example embodiment. In some example embodiments, the lighting system 100 includes a control device 102 and lighting fixtures 104-110. The control device 102 may receive wireless (RF) signals from the lighting fixtures 104-110 and may process the wireless signals to determine the location of the mobile entity 112 as described below. The mobile entity 112 may be a robotic lawn mower, a pet collar worn by a pet, a robotic vacuum cleaner, etc. The control device 102 may include a lighting fixture that includes a microcontroller/microprocessor 120 along with support components, such as a memory device 122 (e.g., flash memory), a communication module, etc. to perform operations described herein. Alternatively, the control device 102 may be another lighting fixture or a standalone control device that includes the microcontroller/microprocessor 120 along with support components (e.g., the memory device 122), a communication module, etc. The control device 102 may be located indoors or outdoors. The microcontroller/microprocessor 120 of the control device 102 may execute software code stored in the memory device 122 to perform some of the operations described herein with respect to the control device 102.

In some example embodiments, one or more of the lighting fixtures 104-110 may be outdoor lighting fixtures such as landscape lighting fixtures, lighting fixtures that are mounted on an eave or an external wall of a building, pole mounted lighting fixtures, etc. Each lighting fixture 104-110 may be within a transmission range of the wireless signal 118 to receive the wireless signal 118 from the mobile entity 112. Each lighting fixture 104-110 may process the received wireless signal 118 to identify the source of the wireless signal 118, for example, by determining the network address and/or other identification information included in the wireless signal 118.

In some example embodiments, the wireless signal 118 may include information that indicates the transmission power level of the wireless signal at the mobile entity 112. The lighting fixtures 104-110 may extract the transmission power level information from the wireless signal 118. The lighting fixtures 104-110 may also determine the reception power level of the wireless signal at the reception of the wireless signal 118 by the respective lighting fixture 104-110. The lighting fixtures 104-110 may transmit to the control device 102 the transmission power level of the wireless signal 118 and the reception power level of the wireless signal 118 along with the identification information of the control device 102. For example, the lighting fixtures 104-110 may transmit the information to the control device via wireless signals.

In some example embodiments, the wireless signal 118 may include transmission time information that indicates the time at the transmission of the wireless signal 118 by the mobile entity 112. For example, the mobile entity 112 may include the transmission time information in the wireless signal 118. The mobile entity 112 may include transmission time information in the wireless signal 118 periodically, based on events, and/or whenever the mobile entity 112 transmits the wireless signal 118. The lighting fixtures 104-110 may receive the wireless signal 118 and extract the transmission time information from the wireless signal 118. The lighting fixtures 104-110 may also determine the time of arrival (i.e., reception time) of the wireless signal 118 at the respective lighting fixture 104-110. The lighting fixtures 104-110 may transmit to the control device 102 the transmission time information extracted from the wireless signal 118 and the reception time information of the wireless signal 118 at the lighting fixtures 104-110 along with the identification information of the control device 102.

In some example embodiments, the control device 102 may receive the information transmitted by two or more of the lighting fixtures 104-110 and estimate the location of the mobile entity 112. For example, the control device 102 may estimate the location of the mobile entity 112 in terms of distances from two or more of the lighting fixtures 104-110. The control device 102 may use the transmission and reception power level information received from at least two of the lighting fixtures 104-110 to estimate the location of the mobile entity 112. To illustrate, the control device 102 may estimate the location of the mobile entity 112 based on the absolute power levels of the wireless signal 118 at the lighting fixtures 106 and 108 and based on the difference between the transmission power level and the reception power level at the lighting fixture 106 and the difference between the transmission power level and the reception power level at the lighting fixture 108. In some example embodiments, the control device 102 may estimate the location of the mobile entity 112 in a similar manner based on information from three or more of the lighting fixtures 104-110.

In some example embodiments, the control device 102 may receive the transmission time information and the reception time information from two or more of the lighting fixtures 104-110 and estimate the location of the mobile entity 112. To illustrate, the control device 102 may estimate the location of the mobile entity 112 based on the travel times of the wireless signal 118 from the mobile entity 112 to the lighting fixtures 104-110. The travel times of the wireless signal 118 may be determined by the control device 102 based on the transmission time information and the reception time information as can be understood by those of ordinary skill in the art with the benefit of this disclosure. Alternatively, each lighting fixture 104-110 may determine the respective travel time based on the transmission time information and the respective reception time information and transmit to the control device 102 the travel time instead of the transmission and reception time information. The control device 102 may estimate the location of the mobile entity 112 based on the absolute travel times of the wireless signal 118 to two or more of the lighting fixtures 104-110 and/or based on the differences between the travel times of the wireless signal 118 to two or more of the lighting fixtures 104-110 as can be readily understood by those of ordinary skill in the art with the benefit of this disclosure. In some example embodiments, the control device 102 may perform triangulation and/or trilateration to estimate the location of the mobile entity 112.

In some example embodiments, the control device 102 may contain information that defines the digital fence 116 (i.e., the boundary) of a permitted area 114. For example, the digital fence 116 may be defined based on distances from two or more of the lighting fixtures 104-110, and as described above, the control device 102 may estimate the location of the mobile entity 112 based on distances from two or more of the lighting fixtures 104-110. To illustrate, many locations that are a first respective distance from the lighting fixture 104 and a second respective distance from the lighting fixture 106 may be considered as being at the boundary of the permitted area 114, and the locations together may define the overall boundary (i.e., the digital fence 116). For example, the distance information with respect to the lighting fixtures 104-110 may be stored in the control device 102. The control device 102 may determine whether the mobile entity 112 is within the permitted area 114 by comparing the estimated location of the mobile entity 112 against the stored information defining the digital fence 116.

In some example embodiments, the control device 102 may wirelessly transmit a control message to the mobile entity 112 upon determining that the mobile entity 112 is at the digital fence 116 (i.e., at the boundary of the permitted area) and/or outside of the permitted area 114. For example, the control device may transmit the control message to the mobile entity 112 via a wireless signal 120. The control device 102 may identify the mobile entity 112 based on identification information of the mobile entity 112 received from the lighting fixtures 104-110. The control message may simply indicate to the mobile entity 112 that the mobile entity 112 is outside of the permitted area 114 and/or may provide instructions to move in a particular direction (e.g., backward), to power off, etc.

For example, if the mobile entity 112 is a robotic lawn mower, the control device 102 may transmit a control message that instructs the mobile entity 112 to move in a particular direction, and the mobile entity 112 may take an action in response to the control message (e.g., change directions, etc.). As another example, if the mobile entity 112 is a robotic lawn mower, the control device 102 may transmit a control message that instructs the mobile entity 112 to power off, for example, to avoid a dangerous situation, such as falling into a swimming pool. As another example, if the mobile entity 112 is a pet collar worn by a pet, the control device 102 may transmit a control message that instructs the mobile entity 112 to produce an effect, such as a mild electric shock, a vibration, and/or an alarming sound, that would cause the pet to move until the effect is no longer applied.

When the mobile entity 112 moves back to within the permitted area 114, the control device 102 may determine that the mobile entity 112 is no longer outside of the permitted area 114 and may stop transmitting the control message to the mobile entity 112. The control device 102 may also transmit a different control message to the mobile entity 112 when the mobile entity 112 is within the permitted area.

In some example embodiments, the control device 102 may transmit lighting control commands to the lighting fixtures 104-110 to control the lights provided by the lighting fixtures 104-110. For example, the control device 102 may control the lighting fixtures 104-110 to flash, turn on, or turn off their lights as a visual notification that the control device 102 is outside of the permitted area 114.

In some alternative embodiments, the lighting system 100 may be more or fewer lighting fixtures than shown in FIG. 1. In some example embodiments, the lighting fixtures 104-110 may be indoor lighting fixtures. In some alternative embodiments, a network device such as a network router may be used for communication among the different devices. In some alternative embodiments, some communication may be wired instead of or in addition to wireless communication. In some alternative embodiments, the digital fence 116 may have a different shape or size than shown in FIG. 1 without departing from the scope of this disclosure.

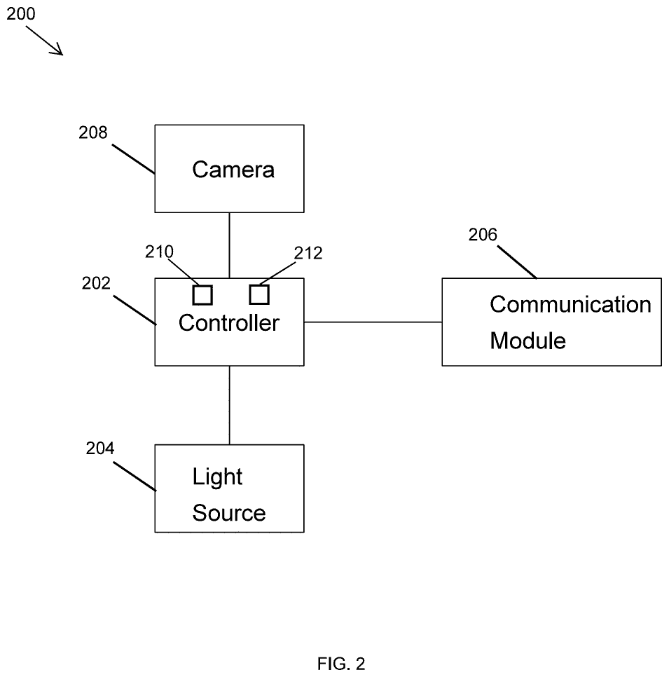

FIG. 2 illustrates a lighting device 200 according to an example embodiment. In some example embodiments, each lighting fixture 104-110 corresponds to the lighting device 200. In some example embodiments, the lighting device 200 may be a lighting fixture such as an outdoor lighting fixture, an indoor lighting fixture, etc. Referring to FIGS. 1 and 2, in some example embodiments, the lighting device 200 may include a controller 202, a light source 204, and a communication module 206. In some example embodiments, the lighting device 200 may also include a camera 206 that may include a video and/or still picture camera.

In some example embodiments, the controller 202 may include a microcontroller/microprocessor 210 along with support components, such as a memory device 212. The microcontroller/microprocessor 210 may execute software code stored in the memory device 212 to perform some of the operations described herein with respect to the lighting fixtures 104-110 of FIG. 1. The controller 202 may also control the operations of the light source 202, for example, based on inputs received via the communication module 206. For example, the microcontroller/microprocessor 210 may execute software code stored in the memory device 212 to control the operations of the light source 202, for example, based on inputs received via the communication module 206.

In some example embodiments, the communication module 206 may include one or more transceivers (or one or more discrete transmitters and receivers) that receive and transmit radiofrequency (wireless) signals, such as Wi-Fi signals. For example, the communication module 206 may receive a wireless signal from a mobile entity, such as the mobile entity 112 shown in FIG. 1, and may transmit a wireless signal to a control device, such as the control device 102 of FIG. 1. The communication module 206 may also receive a wireless signal from a control device, such as the control device 102 of FIG. 1. In some example embodiments, the communication module 206 may also include one or more transceivers (or one or more discrete transmitters and receivers) that receive and transmit signals via a wired connection, such as an Ethernet cable.

In some example embodiments, the controller 202 may control the camera 208 to capture video and/or still images. The controller 202 may transmit the video or still images via the communication module, for example, to the control device 102 of FIG. 1. Alternatively, the controller 202 may process the video and/or image to identify structures, animals, people, etc. and transmit the result of the analysis via the communication module, for example, to the control device 102 of FIG. 1.

In some alternative embodiments, the lighting device may include other components such as power components without departing from the scope of this disclosure. In some alternative embodiments, some of the components of the lighting device 200 may be integrated into a single component.

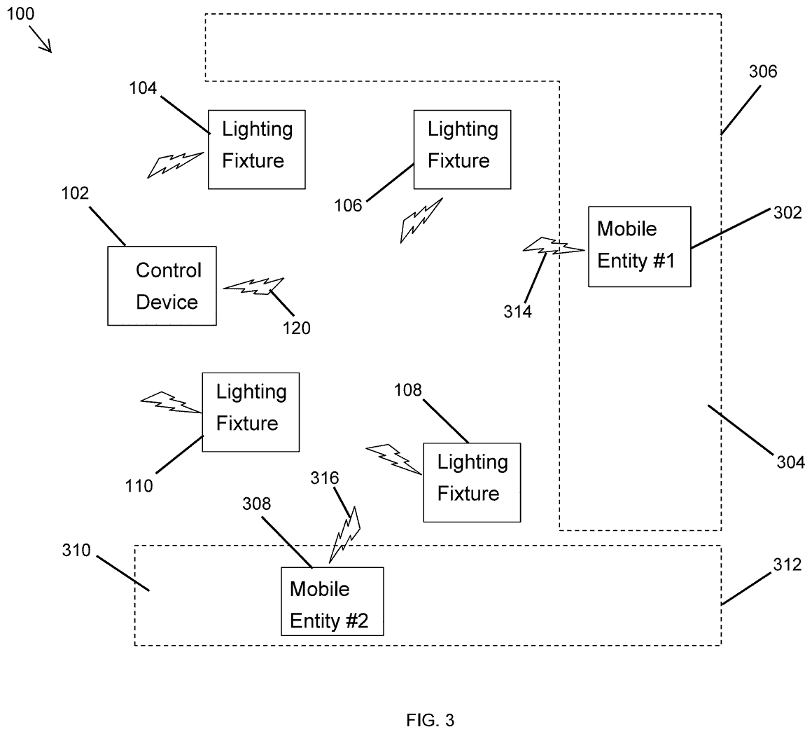

FIG. 3 illustrates the lighting system 100 of FIG. 1 used to establish multiple digital fences 306, 312 based on wireless signals 314, 316 from mobile entities 302, 308 according to an example embodiment. Referring to FIGS. 1-3, the system 100 in FIG. 3 operates as described with respect to FIG. 1 to establish two digital fences 306, 312 instead of one digital fence 116. To illustrate, the mobile entity 302 may transmit a wireless signal 314 that includes identification information of the mobile entity 302. The wireless signal 314 may also include other information such as transmit power level, transmission time, etc. as described above with respect to the wireless signal 118 shown in FIG. 1. The lighting fixtures 104-110 may receive and process the wireless signal 314 in the same manner as described above with respect to the wireless signal 118 in FIG. 1. The lighting fixtures 104-110 may transmit wireless signals to the control device 102 that receives and processes the wireless signals from two or more of the lighting fixtures 104-110 to estimate the location of the mobile entity 302 in a similar manner as described with respect to FIG.

In some example embodiments, the mobile entity 308 may transmit a wireless signal 316 that is received and processed by the lighting fixtures 104-110 in the same manner as the wireless signal 118 shown in FIG. 1. The lighting fixtures 104-110 may transmit wireless signals to the control device 102, and the control device 102 may receive and process the wireless signals from two or more of the lighting fixtures 104-110 to estimate the location of the mobile entity 308 in a similar manner as described with respect to FIG. 1. Because the lighting devices 104-110 transmit information related to the wireless signal 114 in association with the identification information of the mobile entity 302, the control device 102 estimates the location of the mobile entity 302 based on the respective information. Because the lighting devices 104-110 transmit information related to the wireless signal 316 in association with the identification information of the mobile entity 308, the control device 102 estimates the location of the mobile entity 308 based on the respective information.

In some example embodiments, the control device 102 may contain information that defines the digital fence 306 of a permitted area 304 and the digital fence 312 of a permitted area 310. For example, the digital fences 306, 312 may be defined with respect to the identification information of the mobile entities 302, 308, respectively. The digital fences 306, 312 may be defined based on distances from two or more of the lighting fixtures 104-110 as described above with respect to the digital fence 116. The control device 102 may estimate the locations of the mobile entities 302, 308 based on distances from two or more of the lighting fixtures 104-110 and determine/estimate whether the mobile entities 302, 308 are within the permitted areas 304, 310, respectively, in a similar manner as described above with respect to the control device 102 and the mobile entity 112 of FIG. 1.

In some example embodiments, the control device 102 may wirelessly transmit a control message to the mobile entity 302 upon determining that the mobile entity 302 is at the digital fence 306 and/or outside of the permitted area 304 in a similar manner as described with respect to the mobile entity 112 of FIG. 1. The control device 102 may also wirelessly transmit a control message to the mobile entity 308 upon determining that the mobile entity 308 is at the digital fence 312 and/or outside of the permitted area 310 in a similar manner as described with respect to the mobile entity 112 of FIG. 1. For example, the control device 102 may transmit the control messages to the mobile entity 302, 308 via a wireless signal 120. The control device 102 may identify the mobile entities 302, 308 based on the respective identification information received from the lighting fixtures 104-110. The control device 102 may transmit similar control messages as the control message transmitted to the mobile entity 112 in FIG. 1.

In some alternative embodiments, the system 100 may include more or fewer lighting fixtures than shown without departing from the scope of this disclosure. In some alternative embodiments, the areas bound by the digital fences 306, 312 may have a different shape than shown without departing from the scope of this disclosure. In some alternative embodiments, more than one mobile entity may be inside each digital fence without departing from the scope of this disclosure.

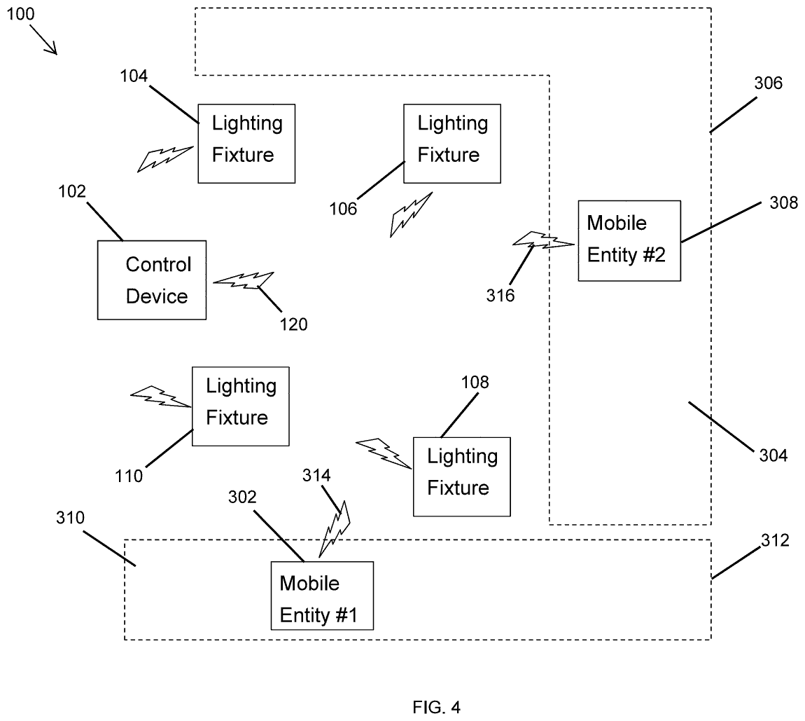

FIG. 4 illustrates the lighting system 100 of FIG. 1 used to establish multiple digital fences 306, 312 based on wireless signals 314, 316 from the mobile entities 302, 308 according to another example embodiment. Referring to FIGS. 1-4, in some example embodiments, the lighting system 100 of FIG. 4 operates in the same manner as described above with respect to FIGS. 1 and 3. In contrast to FIG. 3, in FIG. 4, the digital fence 306 is around the mobile entity 308, and the digital fence 312 is around the mobile entity 302. To illustrate, the digital fence 306 is used to limit the movement of the mobile entity 308, instead of the mobile entity 302, to within the permitted area 304, and the digital fence 312 is used to limit the movement of the mobile entity 302, instead of the mobile entity 308, to within the permitted area 310.

In some example embodiments, the digital fences 306 and 312 may be established (i.e., enforced) around the mobile entities 302 and 308, respectively, after the mobile entities 302, 308 are allowed to move around freely. For example, starting from the locations of the mobile entities 302 and 308 within the digital fences 306 and 312, respectively, shown in FIG. 3, the digital fences 306, 312 may be temporarily removed (i.e., not enforced) until the mobile entities 302 and 308 move to their respective locations within the digital fences 312 and 306, respectively, shown in FIG. 4. After the mobile entities 302, 308 move to their locations shown in FIG. 4, the digital fences 312 and 306 may be established/enforced by the control device 102 in a similar manner as described above with respect to FIGS. 1 and 3. That is, after the mobile entities 302, 308 move to their locations shown in FIG. 4, the control device 102 may transmit control messages to the mobile entities 302, 308 to limit the movements of the mobile entities 302, 308 to within the respective permitted areas 310, 304. As described above, the boundaries of the digital fences 306, 312 may be defined based on distances from two or more of the lighting fixtures 104-110 regardless of whether the mobile entities 302, 308 are inside the digital fences 306, 312.

In some alternative embodiments, the system 100 may include more or fewer lighting fixtures than shown without departing from the scope of this disclosure. In some alternative embodiments, the areas bound by the digital fences 306, 312 may have a different shape than shown without departing from the scope of this disclosure. In some alternative embodiments, more than one mobile entity may be inside each digital fence without departing from the scope of this disclosure.

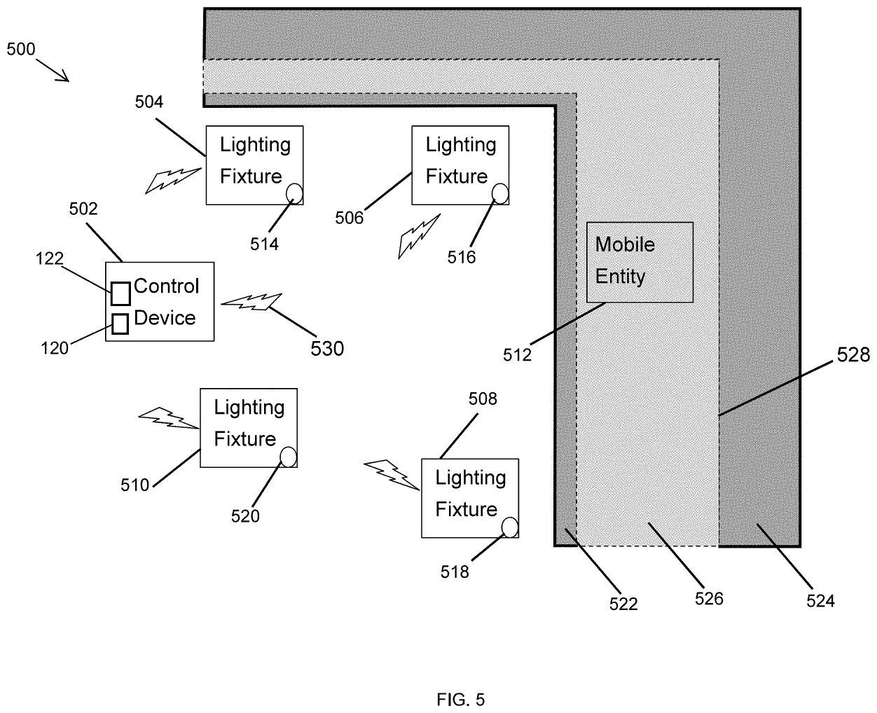

FIG. 5 illustrates a lighting system 500 of lighting devices 504-510 used to establish a digital fence 528 based on image analysis according to an example embodiment. Referring to FIGS. 1-5, in some example embodiments, the lighting system 500 includes a control device 502 and lighting fixtures 504-510. The control device 502 may receive wireless (RF) signals from the lighting fixtures 504-510 and may process the wireless signals to determine the location of a mobile entity 512 as described below. In some example embodiments, the control device 502 may correspond to the control device 102 described with respect to FIG. 1, and the mobile entity 512 may correspond to the mobile entity 112 described with respect to FIG. 1. To illustrate, the control device 502 may include a lighting fixture that includes the microcontroller/microprocessor 120 along with support components (e.g., the memory device 122), a communication module, etc. to perform operations described herein. Alternatively, the control device 502 may be another lighting fixture or a standalone control device that includes the microcontroller/microprocessor 120 along with support components (e.g., the memory device 122, etc.), a communication module, etc. The microcontroller/microprocessor 120 of the control device 502 may execute software code stored in the memory device 122 to perform some of the operations described herein with respect to the control device 502. For example, the microcontroller/microprocessor 120 may process video and/or images to identify the mobile entity 512 and structures (e.g., grass lawn, paved ground, trees, bushes, etc.) using one or more image processing methods known to those of ordinary skill in the art. The control device 502 may be located indoors or outdoors. Each lighting fixture 504-510 may correspond to the lighting device 200 of FIG. 2.

In some example embodiments, one or more of the lighting fixtures 504-510 may be outdoor lighting fixtures such as landscape lighting fixtures, lighting fixtures that are mounted on an eave or an external wall of a building, pole mounted lighting fixtures, etc. One or more of the lighting fixture 504-510 may include a respective camera that can capture video and/or still images. For example, the lighting fixture 504 may include a camera 514. The lighting fixture 506 may include a camera 516. The lighting fixture 508 may include a camera 518. The lighting fixture 510 may include a camera 520. The respective camera of each lighting fixture 504-510 may capture video and/or still images of an area that is with the field of view of the camera.

In some example embodiments, the lighting fixtures 504-510 may transmit video and/or images captured by the respective cameras 514-520 to the control device 502, for example, via wireless signals. The control device 502 may receive the video and/or images from the lighting fixtures 504-510 and process the received video and/or images to identify mobile entities (e.g., a lawn mower, pets, people, etc.) and structures (e.g., a grass lawn, paved surfaces, trees, etc.). To illustrate, the control device 502 may include image data corresponding to different mobile entities and structures and may use the image data to identify the mobile entity 512 and structures. For example, the control device 502 may identify the mobile entity 512 as a lawn mower, a pet, or another mobile entity. The control device 502 may also process the received video or image to identify structures such as a grass lawn, paved surfaces, trees, etc. For example, the control device 502 may identify areas 522 and 524 as paved surfaces and may identify the area 526 as a grass lawn. The control device 502 may also determine from the image analysis of the received video and/or images the distance/separation between the mobile entity 512 and the different areas 522, 254, 526. For example, the control device 502 may determine that the mobile entity 512 is in the area 526 based on an image analysis of the video and/or images from the lighting fixtures 504-510.

In some example embodiments, the control device 502 may be programmed with information that associates various mobile entities with one or more types of permitted or prohibited areas. For example, the control device 502 may be programmed with information that indicates that a lawn mower is permitted in a grass lawn. As another example, the control device 502 may be programmed with information that indicates that a pet is permitted in an area that has a paved surface. The control device 502 may be programmed or provided with information that indicates the identification information (e.g., a network address, serial number, etc.) of the mobile entity 512 that allows the control device 502 to transmit a wireless signal 530 to the mobile entity 512. To illustrate, upon identifying the mobile entity 512 as a lawn mower (e.g., a robotic lawn mower), the areas 522, 526 as paved surfaces, and the area 526 as a grass lawn, the control device 502 may transmit, via the wireless signal 530, a control message to the mobile entity 512 whenever the mobile entity 512 moves off the area 526 and onto the area 522 or 524 in a similar manner as described with respect to the control device 102 and the mobile entity 112 of FIG. 1.

As another example, upon identifying the mobile entity 512 as a pet, the areas 522, 526 as paved surfaces, and the area 526 as a grass lawn, the control device 502 may transmit, via the wireless signal 530, a control message to a pet collar of the mobile entity 512 whenever the mobile entity 512 is outside the area 522 or 524 in a similar manner as described with respect to the control device 102 and the mobile entity 112 of FIG. 1. The control device 502 may stop transmitting the control message or may transmit a different control message to the pet collar of the mobile entity 512 when the control device 502 determines that the mobile entity 512 is located in the area 522 or 524.

In some alternative embodiments, the lighting fixtures 504-510 may each transmit to the control device 502 information that includes the results of image processing performed by the respective controller of the lighting fixtures 504-510. To illustrate, the controller of each lighting fixture 504-510 may process captured videos or images to identify particular mobile entities (e.g., a lawn mower, pets, people, etc.) and structures such as a grass lawn, paved surfaces, trees, etc. For example, the results of the image processing by the lighting fixtures 504-510 may include the categorical identification (e.g., a lawn mower, a pet, a person, etc.) of the mobile entity 512 and the areas 522, 524, 526 (e.g., paved surface, grass lawn, etc.). The results of the image processing may also include distance/separation information between the mobile entity 512 and the areas 522, 524, 526. The control device 502 may receive the information from the lighting fixtures 504-510 and determine whether an identified mobile entity should be in a particular area based on the received information and the information programmed into the control device 502 about the association of particular mobile entities with particular structures, such as areas, objects, etc. Upon determining that the mobile entity is outside of a permitted area, the control device 502 may transmit a control message to inform and/or control/alter the movement of the mobile entity 512 as described above.

By transmitting the control message to the mobile entity 512 to control/alter the movement of the mobile entity 512, the control device 502 effectively establishes (i.e., enforces) the digital fence 528 around an area where the mobile entity 512 is allowed to operate.

In some alternative embodiments, the system 500 may include more or fewer lighting fixtures than shown without departing from the scope of this disclosure. In some alternative embodiments, the system 500 may include some lighting fixtures that do not include a camera without departing from the scope of this disclosure. In some alternative embodiments, the areas 522, 524, 526 may have a different shape than shown without departing from the scope of this disclosure. In some alternative embodiments, more than one mobile entity may be inside the digital fence 528 without departing from the scope of this disclosure.

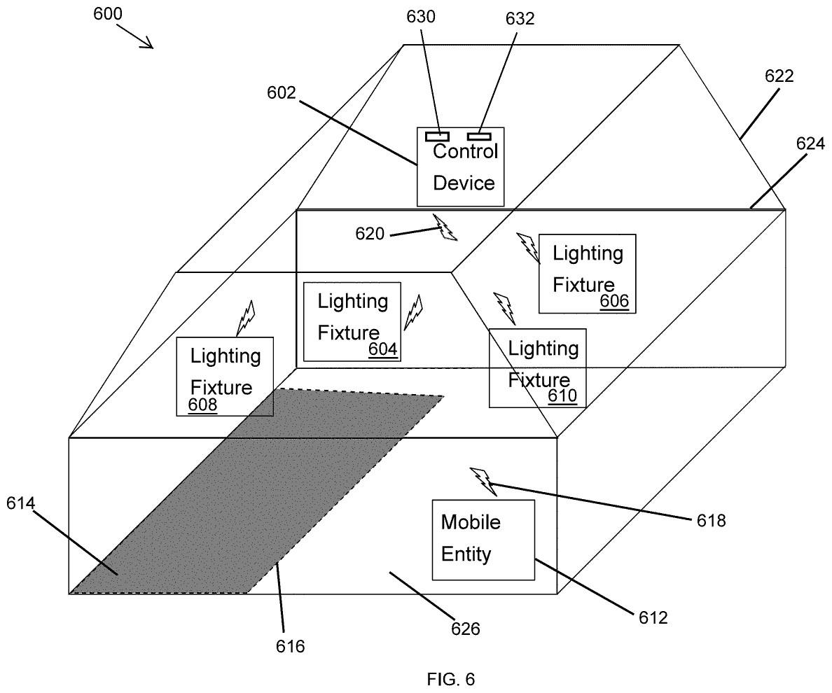

FIG. 6 illustrates a lighting system 600 of lighting devices 604-610 used to establish a digital fence based on a wireless signal 618 from a mobile entity 612 according to another example embodiment. Referring to FIGS. 1-6, in some example embodiments, the lighting system 600 includes a control device 602 and lighting fixtures 604-610. The control device 602 may receive wireless (RF) signals from the lighting fixtures 604-610 and may process the wireless signals to determine the location of the mobile entity 612 as described below. The mobile entity 612 may be a robotic vacuum cleaner, etc. that is used in indoor spaces. The control device 602 may include a lighting fixture that includes a microcontroller/microprocessor 630 along with support components (e.g., a memory device 632, etc.), a communication module, etc. to perform operations described herein. Alternatively, the control device 602 may be another lighting fixture or a standalone control device that includes the microcontroller/microprocessor 630 along with support components (e.g., the memory device 632, etc.), a communication module, etc. The microcontroller/microprocessor 630 of the control device 602 may execute software code stored in the memory device 632 to perform some of the operations described herein with respect to the control device 602. The control device 602 may be located in the same room as the lighting fixtures 604-610 or may be in a different room. Each lighting fixture 604-610 may correspond to the lighting device 200 of FIG. 2.

In some example embodiments, one or more of the lighting fixtures 604-610 may be indoor lighting fixtures such as recessed lighting fixtures, suspended lighting fixtures, etc. For example, one or more of the lighting fixtures 604-610 may be recessed in a ceiling 624 of a building 622. Each lighting fixture 604-610 may be within a transmission range of the wireless signal 618 to receive the wireless signal 618 from the mobile entity 612. Each lighting fixture 604-610 may receive and process the wireless signal 618 to identify the source of the wireless signal 618, for example, by determining the network address and/or another identification information included in the wireless signal 618.

In some example embodiments, the wireless signal 618 may include information described above with respect to the wireless signal 118 and the lighting system 100 of FIG. 1. The lighting fixtures 604-610 may receive and process the wireless signal 618 and may transmit information to the control device 602 in the same manner as described with the lighting fixtures 104-110 and the control device 102 of the system 100 of FIG. 1. Base on the information received from the lighting fixtures 604-610, the control device 602 may determine whether the mobile entity 612 is within a prohibited area 614 or a permitted area 626. For example, the control device 602 may estimate the location of the mobile entity 612 based on the information from the lighting fixtures 604-610 in a similar manner as described with respect to control device 102, the mobile entity 112, and the lighting fixtures 104-110 of FIG. 1. The prohibited area 614 and the permitted area 626 may be separated by the digital (invisible) fence 616. For example, the control device 602 may contain information that defines the digital fence 616 based on distances from two or more of the lighting fixtures 604-610 in a similar manner as described with respect to the digital fence 116 of FIG. 1.

In some example embodiments, the control device 602 may wirelessly transmit a control message to the mobile entity 612 upon determining that the mobile entity 612 is outside of the permitted area 626. For example, the control device may transmit the control message to the mobile entity 112 via a wireless signal 620. The control device 102 may identify the mobile entity 612 based on identification information of the mobile entity 612 received from the lighting fixtures 604-610. The control message may simply indicate to the mobile entity 612 that the mobile entity 612 is in the prohibited area 614 or outside of the permitted area 626. Alternatively or in addition, the control message may provide instructions to the mobile entity 612 to move in a particular direction (e.g., backward), to power off, etc.

For example, if the control device 612 is a robotic vacuum cleaner, the control device 602 may transmit a control message that instructs the control device 612 to move in a particular direction, and the mobile entity 612 may take an action in response to the control message (e.g., change directions, etc.). As another example, the control device 602 may transmit a control message that instructs the control device 612 to power off, for example, to avoid a dangerous situation, such as falling off an edge.

When the mobile entity 612 moves back to within the permitted area 626, for example, in response to instructions from the control device 612, the control device 102 may determine that the mobile entity 612 is no longer outside of the permitted area 626 and may stop transmitting the control message to the mobile entity 622. The control device 602 may also transmit a different control message to the mobile entity 612 when the mobile entity 612 is within the permitted area 626.

In some example embodiments, the control device 602 may transmit lighting control commands to the lighting fixtures 604-610 to control the lights provided by the lighting fixtures 604-610. For example, the control device 602 may control the lighting fixtures 604-610 to flash, turn on, or turn off their lights as a visual notification, for example, to a person in the vicinity of the lighting fixtures 604-610 that the mobile entity 612 is outside of the permitted area 626. Alternatively or in addition, the control device 602 may control the lighting fixtures 604-610 such that one or more of the lighting fixtures 604-610 communicate with the mobile entity 612 using visible light communication (VLC). For example, one or more of the lighting fixtures 604-610 may provide instructions to the mobile entity 612 via a VLC message to move in a particular direction, to stop moving a particular direction, etc. based on the control message received by the one or more of the lighting fixtures 604-610 from the control device 602 via the wireless (RF) signal 620. In some example embodiments, the control device 602 may control/alter the movement of the mobile entity 612 using the VLC messages transmitted by one or more of the lighting fixtures 604-610 instead of or in addition to the communication via the RF signal 620.

In some alternative embodiments, the lighting system 600 may include more or fewer lighting fixtures than shown in FIG. 6. In some alternative embodiments, a network device such as a network router may be used for communication among the different devices of the system 600. In some alternative embodiments, some communication may be wired instead of or in addition to wireless communication. In some alternative embodiments, the digital fence 616 may have a different shape or size than shown in FIG. 6 without departing from the scope of this disclosure. In some example embodiments, more than one mobile entities may be in the areas 614 or 626 and may be controlled by the control device 602.

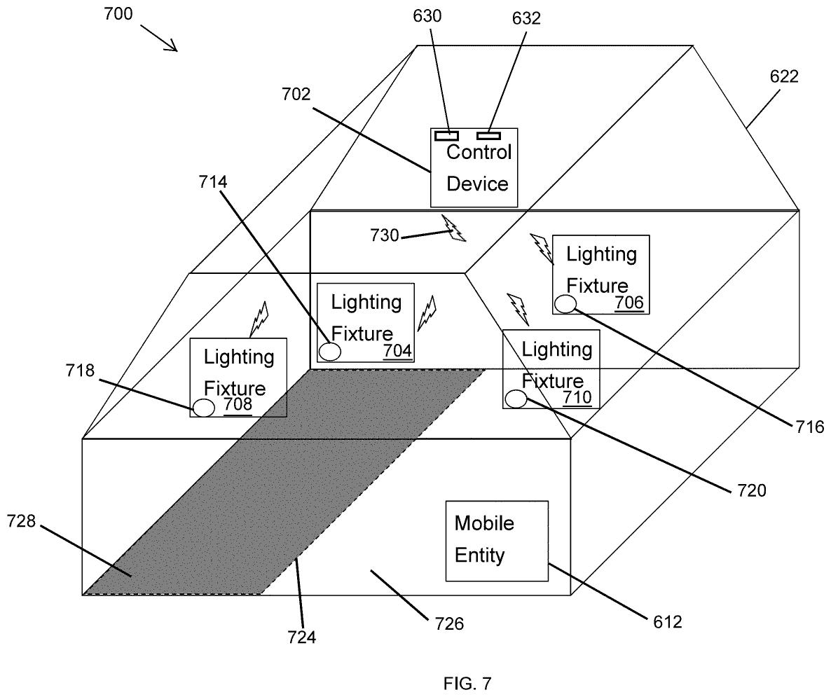

FIG. 7 illustrates a lighting system 700 of lighting devices used to establish a digital fence based on image analysis according to another example embodiment. Referring to FIGS. 1-7, in some example embodiments, the lighting system 700 includes a control device 702 and lighting fixtures 704-710. The control device 702 may receive wireless (RF) signals from the lighting fixtures 704-710 and may process the wireless signals to determine the location of the mobile entity 612 in a similar manner as described with the lighting system 600 of FIG. 6.

To illustrate, in some example embodiments, the control device 702 may correspond to the control device 602 described with respect to FIG. 6, and the mobile entity 612 may correspond to the mobile entity 612 described with respect to FIG. 6. For example, the control device 702 may include a lighting fixture that includes the microcontroller/microprocessor 630 along with support components (e.g., the memory device 632, etc.), a communication module, etc. to perform operations described herein. Alternatively, the control device 702 may be another lighting fixture or a standalone control device that includes a microcontroller/microprocessor 630 along with support components (e.g., the memory device 632, etc.), a communication module, etc. The microcontroller/microprocessor 630 of the control device 702 may execute software code to perform some of the operations described herein with respect to the control device 702. Each lighting fixture 704-710 may correspond to the lighting device 200 of FIG. 2.

In some example embodiments, the control device 702 may control/alter the movement of the mobile entity 612 based on video and/or images captured by one or more cameras 714-720 of one or more of the lighting fixtures 704-710 in a similar manner as described with the lighting system 500 of FIG. 5. For example, the control device 702 may identify mobile entities such as the mobile entity 612 and areas 726 and 728 by analyzing video and/or still images captured by one or more of the cameras 714-720. For example, the microcontroller/microprocessor 630 may process video and/or images to identify the mobile entity 612 and structures the areas 726, 728 using one or more image processing methods known to those of ordinary skill in the art. The control device 502 may be located in the building 622 or the same room as one or more of the lighting fixtures 704-710 or may be at a different location.

In some example embodiments, one or more of the lighting fixtures 704-710 may be indoor lighting fixtures that are mounted in or to a ceiling or a wall in the building 622. The lighting fixtures 504-510 may transmit video and/or images captured by the respective cameras 514-520 to the control device 502, for example, via wireless signals. The control device 702 may receive the video and/or images from the lighting fixtures 704-710 and process the received video and/or images to identify mobile entities (e.g., the mobile entity 612) and structures, such as carpeted floor, hardwood floor, etc. (e.g., the areas 726, 728). To illustrate, the control device 702 may include image data corresponding to different mobile entities and structures and may use the image data to identify the mobile entity 612 and areas 726, 728. For example, the control device 702 may identify the mobile entity 612 as a robotic vacuum cleaner that is used in indoor spaces or as another mobile entity. The control device 702 may also process the received video or image to identify, for example, the area 726 as a tiled area and the area 728 as a carpeted area. The control device 702 may also determine from the image analysis of the received video and/or images the distance/separation between the mobile entity 612 and the different areas 726, 728. For example, the control device 702 may determine that the mobile entity 612 is in the area 726 based on an image analysis of the video and/or images from the lighting fixtures 704-710.

In some example embodiments, the control device 702 may be programmed with information that associates various mobile entities with one or more types of permitted or prohibited areas. For example, the control device 702 may be programmed with information that indicates that a vacuum cleaner is permitted in a carpeted area. As another example, the control device 702 may be programmed with information that indicates that a pet is permitted in a tiled area. The control device 702 may be programmed or provided with information that indicates the identification information (e.g., a network address, serial number, etc.) of the mobile entity 612 that allows the control device 702 to transmit a wireless signal 730 to the mobile entity 612. To illustrate, upon identifying the mobile entity 612 as a robotic vacuum cleaner, the area 726 as tiled area, and the area 728 as a carpeted area, the control device 702 may transmit, via the wireless signal 730, a control message to the mobile entity 612 whenever the mobile entity 612 moves off the area 728 and onto the area 726 in a similar manner as described with respect to the control device 102 and the mobile entity 112 of FIG. 1.

As another example, upon identifying the mobile entity 612 as a pet, the area 726 as tiled area, and the area 728 as a carpeted area, the control device 702 may transmit, via the wireless signal 530, a control message to a pet collar of the mobile entity 612 whenever the mobile entity 612 is outside the area 726 or in the area 728 in a similar manner as described with respect to the control device 102 and the mobile entity 112 of FIG. 1. The control device 702 may stop transmitting the control message or may transmit a different control message to the pet collar of the mobile entity 612 when the control device 702 determines that the mobile entity 612 is located in the area 726.

In some alternative embodiments, the lighting fixtures 704-710 may each transmit to the control device 702 information that includes the results of image processing performed by the respective controller of the lighting fixtures 704-710. To illustrate, the controller of each lighting fixture 704-710 may process captured videos or images to identify particular mobile entities (e.g., a vacuum cleaner, pets, a person, etc.) and structures (e.g., carpeted area, tiled area, a chair, etc.). For example, the results of the image processing by the lighting fixtures 704-710 may include the categorical identification (e.g., a vacuum cleaner, a pet, a person, etc.) of the mobile entity 612 and the areas 726, 728 (e.g., carpeted area, tiled area, furniture,). The results of the image processing may also include distance/separation information between the mobile entity 612 and the areas 726, 728. The control device 702 may receive the information from the lighting fixtures 704-710 and determine whether an identified mobile entity should be in a particular area based on the received information and the information programmed into the control device 702 about the association of particular mobile entities with particular structures, such as areas, objects, etc. Upon determining that the mobile entity 612 is outside of a permitted area, the control device 702 may transmit a control message to inform and/or control/alter the movement of the mobile entity 612 as described above.

By transmitting the control message to the mobile entity 612 to inform and/or control/alter the movement of the mobile entity 612, the control device 702 effectively establishes (i.e., enforces) the digital fence 724 around an area where the mobile entity 612 is or is not allowed to operate.

In some alternative embodiments, the system 700 may include more or fewer lighting fixtures than shown without departing from the scope of this disclosure. In some alternative embodiments, the system 700 may include some lighting fixtures that do not include a camera without departing from the scope of this disclosure. In some alternative embodiments, the areas 726, 728 may have a different shape than shown without departing from the scope of this disclosure. In some alternative embodiments, more than one mobile entity may be inside the areas 726, 728 and may be controlled by the control device 702 without departing from the scope of this disclosure.

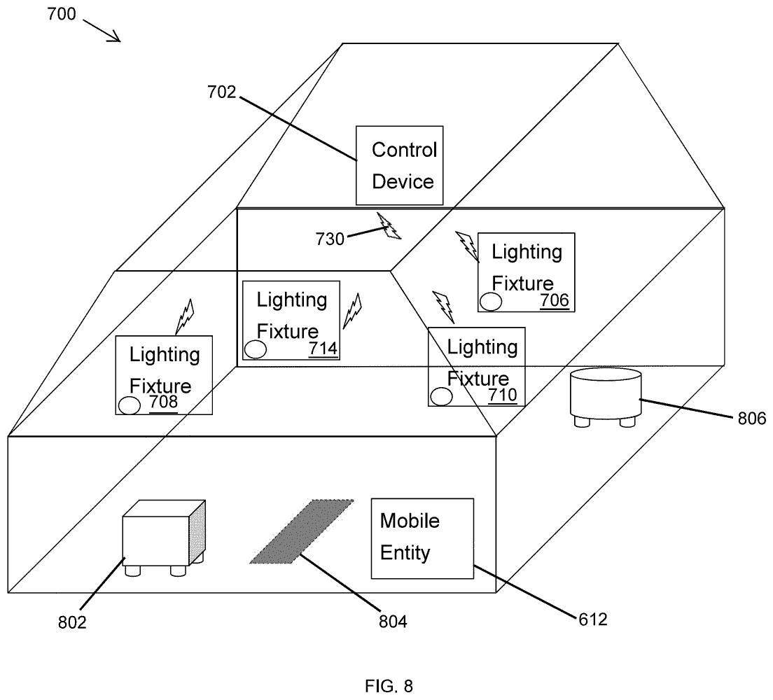

FIG. 8 illustrates the lighting system 700 of FIG. 7 used to guide a mobile entity 612 based on image analysis according to another example embodiment. Referring to FIGS. 7 and 8, in some example embodiments, the lighting system 700 may operate to control/alter the movement of the mobile entity 612 in a similar manner as described with respect to the system 500 of FIG. 5. To illustrate, based on video and/or images captured by one or more cameras 714-720 of one or more of the lighting fixtures 704-710, the control device 702 may guide the mobile entity 612 around objects, such as furniture 802, 806, and a carpet 804. For example, the control device 702 may process the video and/or images captured by the cameras 714-720 and transmitted to the control device 702 to identify different objects such as, the furniture 802, 806, and the carpet 804, as well as the mobile entity 612.

In some example embodiments, the control device 702 may also determine the location of the mobile entity 612 relative to the different objects by analyzing the video and/or images and may guide the mobile entity 612 around the furniture 802, 806, and the carpet 804 as well other around objects such as walls, etc. The control device 602 may implement one or more image processing methods known to those of ordinary skill in the art to identify the mobile entity 612, the furniture 802, 806, the carpet 804, walls, etc. and to determine relative locations of the mobile entity 612 with respect to the furniture 802, 806, the carpet 804, walls, etc.

In some example embodiments, the control device 702 may provide a control message to the mobile entity 612 via the wireless (RF) signal 730 to inform and/or to control movements of the mobile entity 612. Alternatively or in addition, the control device 702 may transmit a control message to one or more of the lighting fixtures 604-610 that generate VLC messages from the control message and to transmit the VLC messages to the mobile entity 612 to inform and/or control movements of the mobile entity 612.

In some alternative embodiments, the system 700 may include more or fewer lighting fixtures than shown without departing from the scope of this disclosure. In some alternative embodiments, the system 800 may include some lighting fixtures that do not include a camera without departing from the scope of this disclosure. In some alternative embodiments, more or fewer structures may be present and identified by the control device 702 without departing from the scope of this disclosure. In some alternative embodiments, more than one mobile entity may be identified and controlled by the control device 702 without departing from the scope of this disclosure.

Although particular embodiments have been described herein in detail, the descriptions are by way of example. The features of the example embodiments described herein are representative and, in alternative embodiments, certain features, elements, and/or steps may be added or omitted. Additionally, modifications to aspects of the example embodiments described herein may be made by those skilled in the art without departing from the spirit and scope of the following claims, the scope of which are to be accorded the broadest interpretation so as to encompass modifications and equivalent structures.

What is claimed is:

1. A digital fencing system, comprising:
a first lighting fixture comprising a first communication module;
a second lighting fixture comprising a second communication module; and
a control device configured to:
receive first information from the first lighting fixture, wherein the first information is related to a wireless signal transmitted by a mobile entity and received by the first lighting fixture;
receive second information from the second lighting fixture, wherein the second information is related to the wireless signal transmitted by the mobile entity and received by the second lighting fixture; and
transmit a control message to the mobile entity to control a movement of the mobile entity based on a location of the mobile entity with respected to a permitted area, wherein the location of the mobile entity is determined based on at least the first information and the second information.

2. The digital fencing system of claim 1, wherein the first information indicates a first power level of the wireless signal at a reception of the wireless signal by the first lighting fixture and wherein the second information indicates a second power level of the wireless signal at a reception of the wireless signal by the second lighting fixture.

3. The digital fencing system of claim 2, wherein the first information indicates a power level of the wireless signal at transmission by the mobile entity.

4. The digital fencing system of claim 1, wherein the first information indicates a first time of arrival of the wireless signal at the first lighting fixture and wherein the second information indicates a second time of arrival of the wireless signal at the second lighting fixture.

5. The digital fencing system of claim 4, wherein the first information indicates a time of transmission of the wireless signal by the mobile entity.

6. The digital fencing system of claim 1, wherein a boundary of the permitted area is defined based on distances from the first lighting fixture and the second lighting fixture.

7. The digital fencing system of claim 1, wherein the mobile entity is a robotic lawn mower and wherein the first lighting fixture and the second lighting fixture are outdoor lighting fixtures.

8. The digital fencing system of claim 1, wherein the mobile entity is a robotic vacuum cleaner and wherein the first lighting fixture and the second lighting fixture are outdoor lighting fixtures.

9. The digital fencing system of claim 1, wherein the control message includes an instruction to the mobile entity to power off.

10. The digital fencing system of claim 1, wherein the control device is configured to transmit the control message to the mobile entity in response to determining that the mobile entity is outside the permitted area.

11. The digital fencing system of claim 1, wherein the control device is configured to stop transmitting the control message to the mobile entity in response to determining that the mobile entity is in the permitted area.

12. A non-transitory computer-readable medium of a controller, wherein the non-transitory computer-readable medium contains instructions executable by a processor, the instructions comprising:
receiving first information from a first lighting fixture, wherein the first information is related to a wireless signal transmitted by a mobile entity and received by the first lighting fixture;
receiving second information from a second lighting fixture, wherein the second information is related to the wireless signal transmitted by the mobile entity and received by the second lighting fixture; and
transmitting, via a transmitter, a control message to the mobile entity to control a movement of the mobile entity based on a location of the mobile entity with respected to a permitted area, wherein the location of the mobile entity is determined based on at least the first information and the second information.

13. The non-transitory computer-readable medium of claim 12, wherein the instructions comprise determining the location of the mobile entity with respected to the permitted area based on at least the first information and the second information.

14. The non-transitory computer-readable medium of claim 12, wherein a boundary of the permitted area is defined based on distances from the first lighting fixture and the second lighting fixture.

15. The non-transitory computer-readable medium of claim 12, wherein the first information indicates a first power level of the wireless signal at a reception of the wireless signal by the first lighting fixture and wherein the second information indicates a second power level of the wireless signal at a reception of the wireless signal by the second lighting fixture.

16. The non-transitory computer-readable medium of claim 12, wherein the first information indicates a first time of arrival of the wireless signal at the first lighting fixture and wherein the second information indicates a second time of arrival of the wireless signal at the second lighting fixture.

17. A digital fencing system, comprising:
a first lighting fixture comprising a first communication module;
a second lighting fixture comprising a second communication module; and
a control device configured to:
receive a first video or image from the first lighting fixture;
receive a second video or image from the second lighting fixture; and
transmit a control message to a mobile entity to control a movement of the mobile entity based on a location of the mobile entity relative to a permitted area, wherein the location of the mobile entity is determined based on at least the first video or image and the second video or image.

18. The digital fencing system of claim 17, wherein the control device is configured to process the first video or image and the second video or image to identify the mobile entity and an area in the first video or image and in the second video or image and to determine the location of the mobile entity relative to the area.

19. The digital fencing system of claim 17, wherein the control device includes information indicating whether the mobile entity is allowed to be in the permitted.

20. The digital fencing system of claim 17, wherein the control device is configured to transmit the control message to the mobile entity via the first lighting fixture.
